(19) United States
(12) Patent Application Publication
(10) Pub. No.: US 2006/0040633 A1
(43) Pub. Date: Feb. 23, 2006

(54) Frequency mixer

(75) Inventors: Takeaki Watanabe, Mukou (JP); Hiroshi Komori, Otsu-shi (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi (JP)

(21) Appl. No.: 11/203,982

(22) Filed: Aug. 15, 2005

(30) Foreign Application Priority Data
Aug. 19, 2004 (JP) JP2004-239256

(51) Int. Cl. H04B 1/00; H04B 1/10; H04B 15/00

(52) U.S. Cl. 455/296; 455/63.1

(57) ABSTRACT

A frequency mixer is provided with a mixer circuit having an input cell that amplifies an input signal and a switching cell that mixes the amplified input signal with a switching signal and outputs a multiplied signal, and a DC offset compensator that detects the input level of the input signal and outputs a compensation signal based on that detection signal, and compensates the DC offset included in the output signal of the mixer circuit by supplying the compensation signal to the mixer circuit. The DC offset compensator is provided with a detector of the input signal level that is input to the mixer circuit, a limiter circuit that attaches a limit to the output of the detector, and a controller that generates a signal that compensates the DC offset included in the mixer output signal based on the limited detector output. When a high-level signal is input, DC offset due to second order nonlinear distortion is compensated while preventing a deterioration in the properties of the mixer circuit due to the compensation signal becoming too large.

### BACKGROUND OF THE INVENTION

1. Field of the Invention

The present invention relates to DC offset compensation in a frequency mixer that mixes an input signal and a switching signal, and outputs a multiplied signal. It is particularly related to a frequency mixer that is applied to a direct conversion wireless receiver and is provided with a DC offset control function suitable for compensating DC offset generated when an interfering frequency is input.

2. Description of Related Art

In recent years, technology that uses a direct-conversion system has been proposed in connection with miniaturization and price reduction of wireless receivers. In this system, an RF input signal is directly converted to a low frequency baseband signal, and so in comparison to a super heterodyne system that requires a high intermediate frequency, it has the advantage that an intermediate frequency filter becomes unnecessary.

Frequency conversion is performed by mixing with a local signal having the same frequency as the RF input signal frequency However, in a direct conversion system, when second order nonlinear distortion is present in the mixer circuit, DC offset occurs in the output baseband signal in accordance with the level of the input signal. This condition will be explained in detail with reference to FIG. 10 and FIG. 11.

FIG. 10 shows the spectrum of an input RF signal, with numeral 101 indicating a weak-level desired frequency whose center frequency is the same as a local signal frequency f_{LO}, and numeral 102 indicating a high-level interfering frequency that is present at a frequency f_{INT} that is different from f_{LO}. As a result of inputting an RF input signal accompanied by such a high-level interfering frequency to a mixer circuit, the spectrum of the output signal appearing in the mixer output becomes as shown in FIG. 11. Numerals 103 and 104 respectively indicate the components that appear in the mixer output after frequency conversion of the desired frequency 101 and the interfering frequency 102 of the RF input. Numeral 105 indicates the DC offset generated by the high-level interfering frequency 102 when second order nonlinear distortion is present in the mixer circuit. In this way, in a direct conversion system, there is the problem that receiver sensitivity decreases because of the DC offset 105 generated in the frequency range of the desired frequency 103 of the mixer output. If the mixer circuit is composed of a differential circuit, and the balance between differentials is completely symmetrical, second order nonlinear distortion will not be present. However, because the components constituting the differential circuit cannot be made completely symmetrical due to manufacturing irregularities, it is not possible to eliminate second order nonlinear distortion.

Therefore, technology has been proposed in the specification of U.S. Pat. No. 6,535,725 that compensates DC offset generated by second order nonlinear distortion.

The method for detecting an interfering frequency included in the RF signal and compensating DC offset generated in the mixer output that is disclosed in U.S. Pat. No. 6,535,725 is explained below with reference to FIG. 12.

In FIG. 12, numeral 106 indicates a mixer circuit, comprising a switching cell 107 and an RF input cell 108. The switching cell 107 comprises bipolar transistors Q1, Q2, Q3, and Q4. The RF input cell 108 comprises bipolar transistors Q5 and Q6, and resistors R. The RF signal input from RF input terminals 109 and 110 is amplified in the RF input cell 108. The amplified RF signal is converted to a baseband signal whose center frequency is DC(IF signal) by being mixed with a local signal input from local input terminals 111 and 112 in the switching cell 107, and this converted IF signal is output from output terminals 113 and 114.

If all of the transistors Q1, Q2, Q3, and Q4 constituting the switching cell 107 have exactly the same characteristics, balance as a differential circuit will be completely symmetrical. However, because the bipolar transistors Q1, Q2, Q3, and Q4 each individually have properties that differ from the ideal properties due to manufacturing irregularities, second order nonlinear distortion is generated when the RF input signal is converted to an IF signal. Therefore, DC offset is generated in the mixer output as shown in FIG. 11. As is well known, because the DC offset is proportional to the square of the input signal strength, the higher the level of the interfering frequency included in the input signal the greater the output DC offset will become.

On the other hand, the circuit shown in FIG. 12 is provided with a DC offset compensator 115. The DC offset compensator 115 comprises a detector 116 and a controller 117. The detector 116 detects an input RF signal and outputs a detection signal. The controller 117 adjusts the magnitude of the detection signal such that it reduces the DC offset at the mixer output terminals 113 and 114, and generates a compensation signal. By this operation of the DC offset compensator 115, the compensation signal that the controller 117 outputs to the mixer circuit 106 changes in response to the strength of the RF signal input, and the DC offset of the mixer output is cancelled.

Because the second order nonlinear distortion properties of each individual element in the mixer circuit 106 differ due to manufacturing irregularities, in the DC offset compensator 115 it is further possible to adjust, with the control signal input from the terminal 18, the magnitude of the compensation signal that the controller 117 generates.

Incidentally, in the GSM system, which is one of the communications systems, there is an AM suppression test wherein the DC offset components due to second order nonlinear distortion cannot be separated from the desired frequency because an interfering frequency is input in the midst of a receiving slot, and there is a blocker test wherein it is possible to separate the DC offset components due to second order nonlinear distortion and the desired frequency with information other than from the receiving slot, because an interfering frequency is constantly input. The interfering frequency input level is −31 dBm for the AM suppression test, and a maximum −23 dBm interfering frequency is input for the blocker test.

In conventional frequency mixers, however, because the compensation signal is not provided with an upper limit, when a much larger signal enters than when performing AM suppression, the compensation signal becomes extremely large and may invite a deterioration in properties by shifting the operating point of the mixer circuit.

### SUMMARY OF THE INVENTION

Therefore, with the foregoing in mind, it is an object of the present invention to provide a frequency mixer wherein, while preventing the deterioration of properties of the mixer circuit due to the compensation signal becoming too large when an extremely high-level signal enters, it is possible to compensate DC offset due to second order nonlinear distortion that cannot be separated from a desired frequency such that it becomes a problem in the AM suppression test in a GSM system.

In order to realize the objective described above, the mixer of the present invention includes: a mixer circuit having an input cell that amplifies an input signal, and a switching cell that mixes the amplified input signal with a switching signal and outputs a multiplied signal, and a DC offset compensator that detects the input level of the input signal and outputs a compensation signal based on that detection signal. The DC offset included in the output signal of the mixer circuit is compensated by supplying the compensation signal to the mixer circuit. The DC offset compensator includes: a detector of the input signal level that is input to the mixer circuit, a limiter circuit that attaches a limit to the output of the detector, and a controller that generates a signal that compensates the DC offset included in the mixer output signal, based on the limited detector output.

### BRIEF DESCRIPTION OF THE DRAWINGS

FIG. 1 is a structural overview diagram that shows the frequency mixer according to a first embodiment of the present invention.

FIG. 2 is an internal circuit structure diagram of the same frequency mixer.

FIG. 3 is an internal circuit structure diagram of the detector included in the same frequency mixer.

FIG. 4 is a graph that shows the change in the detector output current versus RF input level.

FIG. 5 is an internal circuit structure diagram of the limiter circuit included in the frequency mixer in FIG. 1.

FIG. 6 is a graph that shows the change in the limiter output current from the same limiter circuit.

FIG. 7 is a circuit diagram that shows an example configuration of the controller included in the frequency mixer in FIG. 1.

FIG. 8 is an internal circuit structure diagram of the limiter circuit included in the frequency mixer according to a second embodiment of the present invention.

FIG. 9 is a graph that shows the change in the limiter output current from the limiter circuit in FIG. 8.

FIG. 10 is a drawing that shows an example of the input signal spectrum in a typical frequency mixer.

FIG. 11 is a drawing that shows the mixer output signal spectrum when DC offset compensation is not performed.

FIG. 12 is an internal circuit structure diagram that shows an example conventional frequency mixer.

### DETAILED DESCRIPTION OF THE INVENTION

In the frequency mixer of the present invention, a configuration may be adopted wherein an RF signal is input as an input signal, a local signal is supplied to a switching cell as a switching signal, and an IF signal is output as a multiplied signal that is output from the switching cell.

It is also possible to adopt a configuration wherein, within the limiter circuit, a transistor is provided that deducts the detector output from a constant current source, and performs a saturation operation when the detector output is larger than the current value of the constant current source.

It is also possible to adopt a configuration wherein a feedback loop that operates such that the detector output is matched to a reference potential is provided in the limiter circuit.

It is also possible for the DC offset compensator to be configured so that DC offset is compensated by adding the compensation signal to the output signal of the input cell.

Hereinafter, the present invention will be described by way of illustrative embodiments with reference to the drawings.

### Embodiment 1

Hereinafter, the frequency mixer according to a first embodiment of the present invention is explained with reference to the drawings.

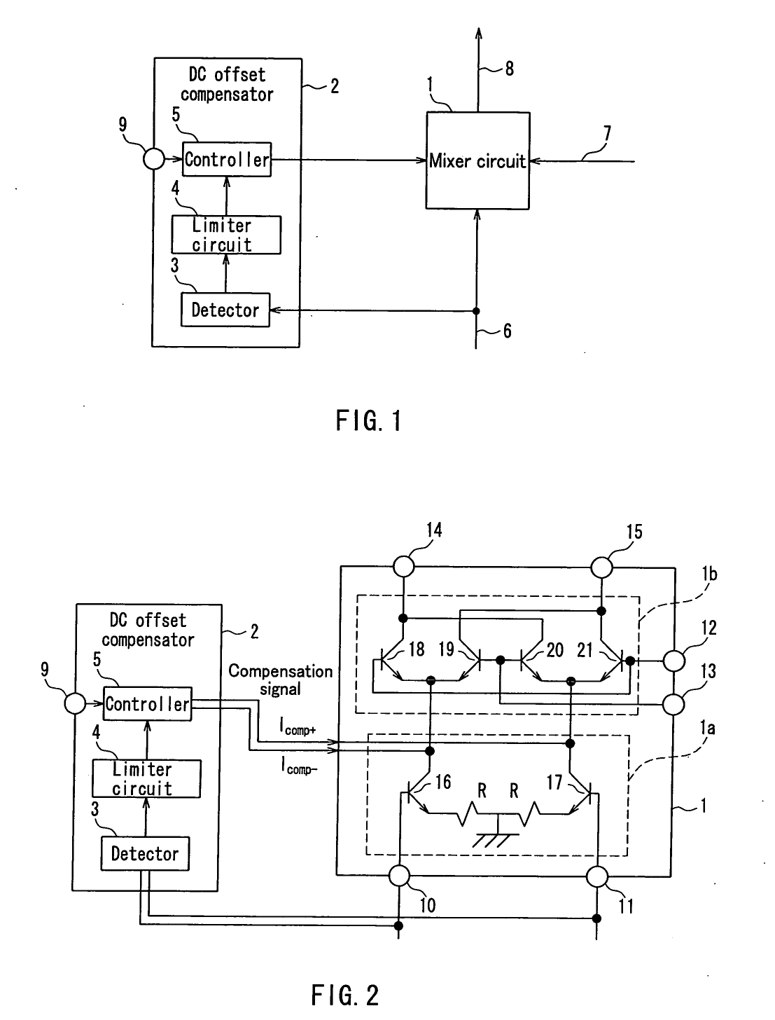

First, FIG. 1 is a structural overview diagram that shows the frequency mixer according to the present embodiment. Numeral 1 indicates a mixer circuit and numeral 2 indicates a DC offset compensator. The DC offset compensator 2 includes a detector 3, a limiter circuit 4, and a controller 5. Numeral 6 indicates an RF input line, numeral 7 indicates a local input line, numeral 8 indicates a mixer output line, and numeral 9 indicates an control signal input terminal.

An RF input signal is converted to a baseband signal (IF signal) by being mixed with a local signal in the mixer circuit 1, and is output from the mixer output line 8. The detector 3 detects an RF input level and outputs a detection signal. The limiter 4 limits the detection signal. The controller 5 receives the detection signal, and adjusts the magnitude of the detection signal to generate a compensation signal. When the RF input level is below a threshold value, the detection signal passes through without being limited by the limiter circuit 4. After the detection signal is adjusted to the magnitude to be converted to a compensation signal in the controller 5, it is input to the mixer circuit 1.

Due to second order nonlinear distortion in the mixer circuit, an interfering frequency included in the RF input signal causes a DC offset to be generated in the mixer output signal, but the compensation signal acts in the mixer circuit 1 so as to reduce the DC offset included in the mixer output signal. Also, because the characteristics of second order nonlinear distortion in the mixer circuit 1 differ for each individual element due to manufacturing irregularities, the control signal input terminal 9 is provided in the DC offset compensator 2, and the compensation signal that the controller 5 generates can be adjusted appropriately.

FIG. 2 is an internal circuit structure diagram of the frequency mixer described above. The mixer circuit 1 includes an RF input cell 1a and a switching cell 1b. Numerals 10 and 11 indicate RF input terminals, numerals 12 and 13 indicate local input terminals, and numerals 14 and 15 indicate output terminals. The RF signal that is input from the RF input terminals 10 and 11 is amplified by the RF input cell 1a, the amplified RF signal is mixed with the local signals from the local input terminals 12 and 13 by the switching cell 1b, and is then output from the output terminals 14 and 15.

The RF input cell 1a includes transistors 16 and 17 and resistors R, and the RF input terminals 10 and 11 are connected to the bases of the transistors 16 and 17.

The compensation signal that the controller 5 outputs is coupled to the collector terminal of the transistors 16 and 17 that constitute the RF input cell 1a. Accordingly, a signal wherein the compensation signal is superimposed on the RF signal is input to the switching cell 1b. By inputting the compensation signal to the switching cell 1b, the operating current of the switching cell 1b changes.

As stated above, the DC offset that is caused in the mixer output signal by the high-level interfering frequency included in the RF signal is decreased by the effect in the switching cell 1b of the compensation signal input to the RF input cell 1a, achieving DC offset compensation. Also, when the RF input signal level is greater than the threshold value, a limit is put on the detection signal by the limiter circuit 4, and by suppressing an increase in the compensation signal, it is possible to suppress a shift in the operating point of the mixer circuit 1 that leads to worsening properties.

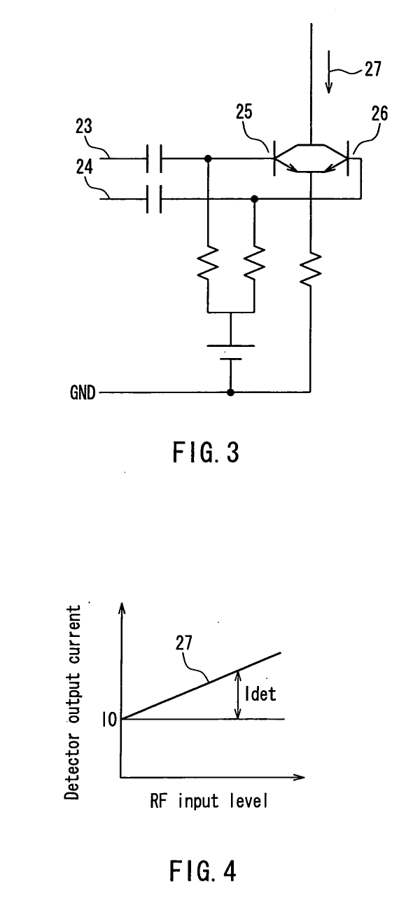

This will be explained in detail with reference to FIG. 3 through FIG. 5. FIG. 3 shows an example configuration of the detector, wherein numerals 23 and 24 indicate RF input lines that are connected to the base of transistors 25 and 26. Numeral 27 indicates a detector output current. FIG. 4 shows the change in the detector output current 27. The horizontal axis shows the RF input level, and the vertical axis shows the magnitude of the detector output current 27. The detector output current 27 is set to be I0 when the RF input signal is zero. Because of the second order nonlinearity the increased DC currents are generated in the collector currents of the transistors 25 and 26 as the RF input level increases, and the detector output current 27 that is the sum of those collector currents increases as shown in FIG. 4. Idet is the increased portion of the detector output current 27.

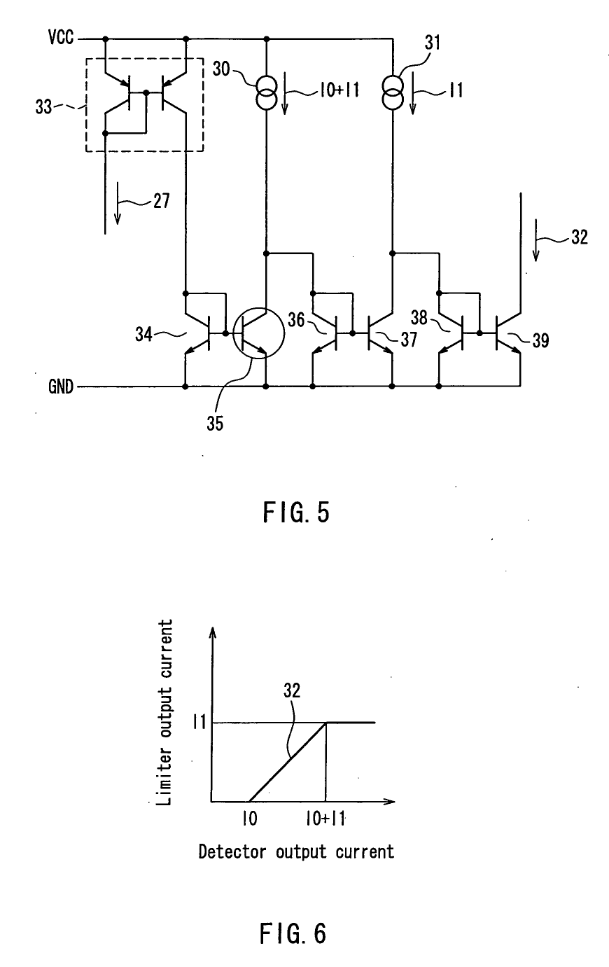

The detector output current 27 is input to the limiter circuit of FIG. 5. FIG. 5 is an internal circuit structure diagram of the limiter circuit, wherein numerals 30 and 31 indicate current sources, and numeral 32 indicates a limiter output current. In the operation of this circuit, first, the detector output current (I0+Idet) is supplied through a current mirror 33, and the difference from a current of the current source 30 is taken by the transistors 34 and 35 to be the collector current of a transistor 36. In this operation, when the current value of the current source 30 is set to (I0+I1), the collector current of the transistor 36 becomes (I1−Idet). Further, the difference between (I1−Idet) and the current source 31 is taken by the transistor 36 and a transistor 37 to be the collector current of the transistor 37. When the current value of the current source 31 is set to I1, the collector current of the transistor 37 becomes Idet. Accordingly, the limiter output current 32 is made Idet by transistors 38 and 39.

That is, only Idet, corresponding to the portion increased from when the detector output current 27 is not input, is sent to the controller 5 in the next stage. Accordingly, when considering a state in which the RF input signal grows large and Idet exceeds I1, although the current of the transistor 34 continues to increase, the transistor 35 performs a saturation operation and the collector current becomes constant at I0+I1. Therefore, the collector current of the transistor 36 becomes zero, and the limiter output current 32 does not exceed above I1.

The change in the limiter output current 32 due to the above operation is shown in FIG. 6. The horizontal axis shows the detector output current, and the vertical axis shows the limiter output current. As shown in FIG. 6, even if the RF input level surpasses the threshold value, the limiter output current does not become greater than I1, and even if the limiter output current 32 is input via the controller 5 in the next stage and into the mixer circuit 1, it is possible to prevent a large shift in the operating point of the mixer that leads to a deterioration in properties.

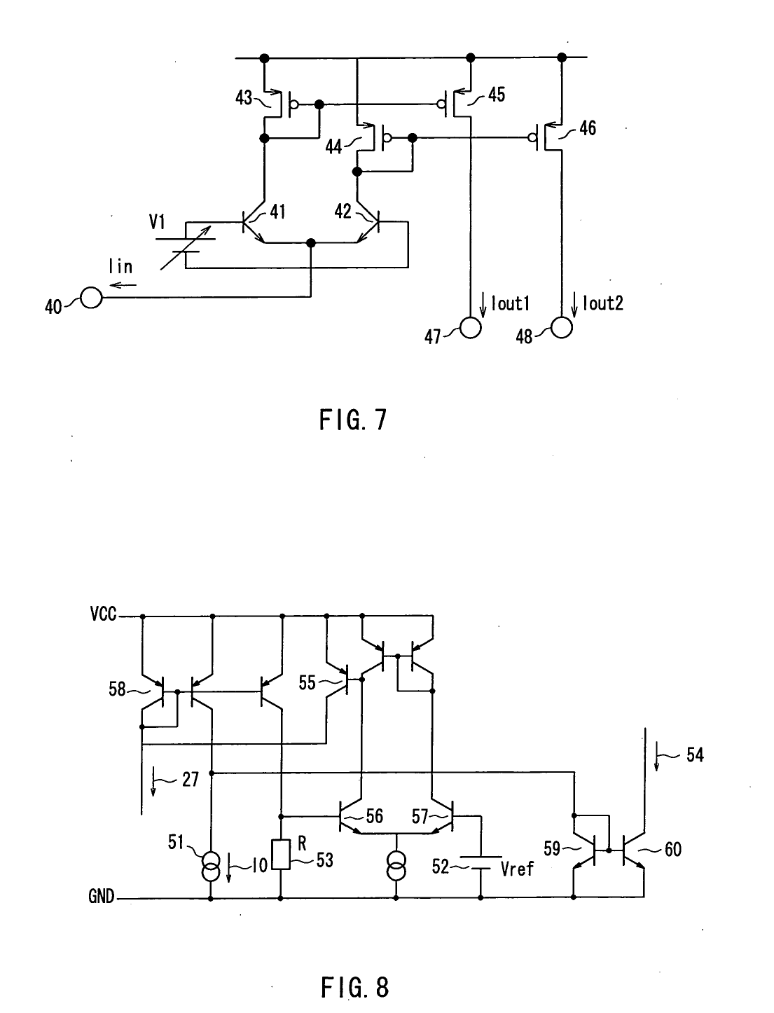

Next, FIG. 7 shows a specific example configuration of the controller 5. Numeral 40 indicates an input terminal. Transistors 41 and 42 constitute a differential circuit. The current ratio that flows to the transistors 41 and 42 is controlled by a control voltage V1 applied between the bases of the transistors 41 and 42. The outputs of the differential circuit are output as compensation currents Iout1 and Iout2 from output terminals 47 and 48 via P-channel FETs 43, 44, 45, and 46.

A limiter output current Iin from the limiter circuit 4 is input from the input terminal 40, and drives the currents flowing through the transistors 41 and 42 that constitute a differential circuit. The ratio of the collector currents that flow to the transistors 41 and 42 are controlled by the control voltage V1, the collector currents that respectively flow to transistors 41 and 42 are folded respectively by the P-channel FETs 43 and 45 and by P-channel FETs 44 and 46 that constitute current mirrors, and are output from output terminals 47 and 48.

The compensation currents Iout1 and Iout2 that are respectively output from the output terminals 47 and 48 are proportional to the detection current Iin that is input from the input terminal 40. When the control voltage V1 is positive, the collector current of the transistor 41 becomes larger than the collector current of the transistor 42, and the output compensation current Iout1 becomes larger than Iout2. That is, a positive offset is generated in the compensation current difference (Iout1−Iout2). Conversely, when the control voltage V1 is negative, a negative offset is generated in the compensation current difference (Iout1−Iout2). In this way it is possible for the offset amount of the compensation current to be controlled with the control voltage V1.

In the present embodiment, DC offset is compensated by superimposing the compensation signal that is output by the DC offset compensator 2 onto the output signal of the RF input cell 1a. Due to the compensation signal being input to the switching cell 1b, even if low frequency noise is included in the DC offset compensation signal, in the mixer output it is converted to a frequency near that of the local signal. Accordingly, it is possible to compensate the DC offset such that the low frequency noise does not range over the frequency range of the desired signal in the mixer output.

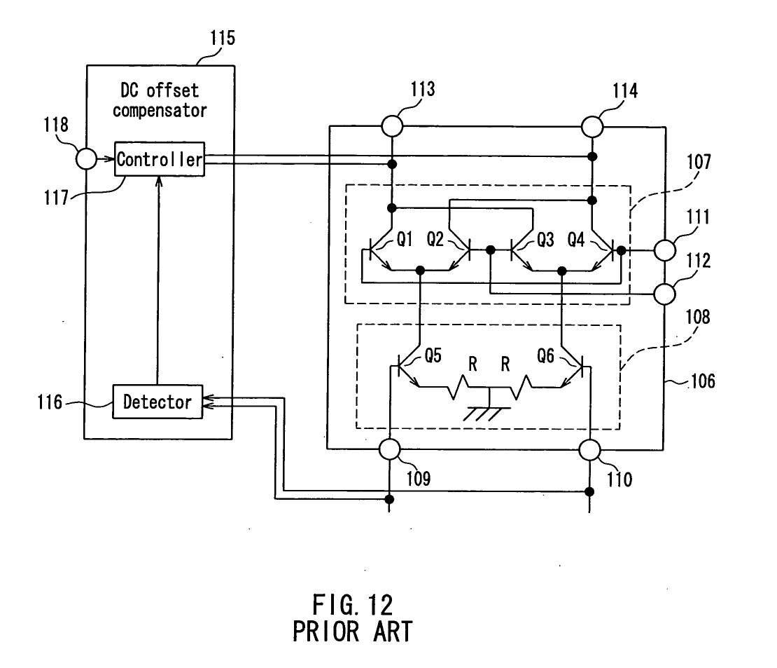

However, a manner of inputting the compensation signal that is output by the DC offset compensator 2 to the mixer circuit 1 is not limited to the configuration described above. For example, as in the conventional example shown in FIG. 12, a configuration may be adopted wherein the output of the controller 5 is supplied to the output terminals 14 and 15.

### Embodiment 2

FIG. 8 shows the limiter circuit included in the frequency mixer according to a second embodiment of the present invention. The basic configuration of the frequency mixer as a whole is the same as the first embodiment shown in FIG. 1. In FIG. 8, numeral 51 indicates a current source, numeral 52 indicates a reference potential, numeral 53 indicates a resistor, and numeral 54 indicates a limiter output current. Numerals 55 though 60 indicate transistors.

When the current value of the current source 51 is set to I0, a difference between I0−Idet and the detector output current 27 becomes Idet. Accordingly, only Idet, corresponding to the portion increased from when the detector output current 27 is not input, is sent by the transistors 59 and 60 to the controller 5 in the next stage as the limiter output current 54 (see FIG. 1).

Here the case of a large RF signal is considered. First, the reference potential 52 is expressed as Vret and the resistance value of the resistor 53 is expressed as R. When the RF input level increases and I0+Idet, which is the detector output current 27, exceeds Vref/R, the base electric potential of the transistor 56 becomes higher than the base electric potential of the transistor 57, and the difference between the collector current of the transistor 56 and the collector current of the transistor 57 becomes the base current of the transistor 55. As a result, the collector current of the transistor 55 flows into the detector 3, and reduces the collector current of the transistor 58. When the collector current of the transistor 58 decreases to Vref/R, the base current of the transistor 55 becomes zero and balances.

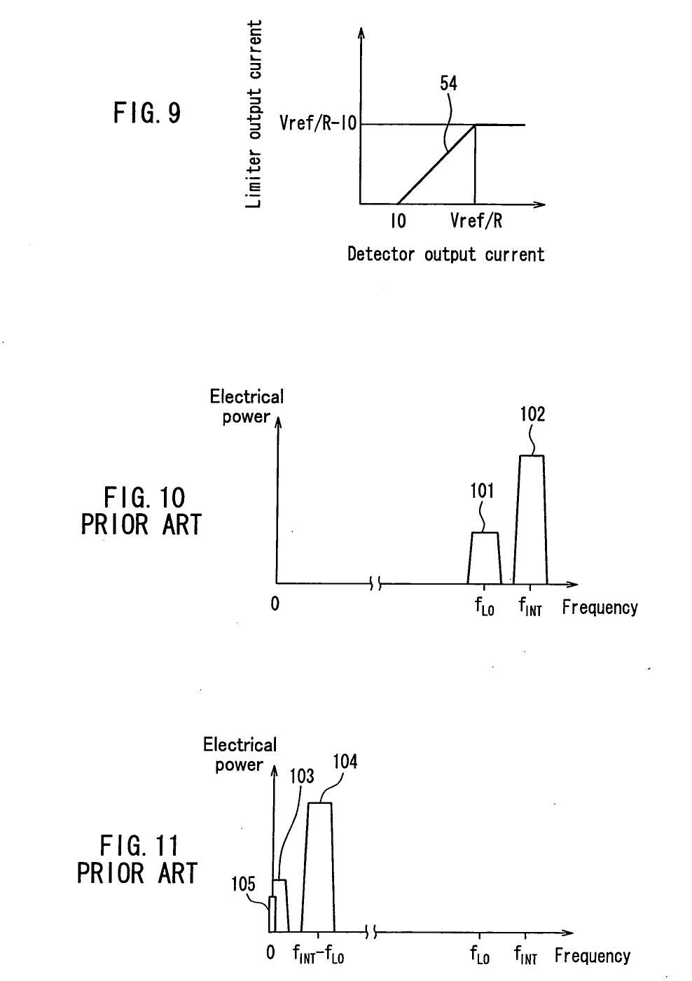

Due to the feedback operation described above, as shown in FIG. 9, even when the RF input level becomes extremely large, the limiter output current 54 does not become larger than Vref/R−I0, and therefore if Vref is set to an appropriate value, even if the limiter output current passes the controller in the next step and is input to the mixer circuit 1, it is possible to prevent a shift in the operating point of the mixer that leads to a deterioration in properties.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A frequency mixer comprising:
a mixer circuit having an input cell that amplifies an input signal, and a switching cell that mixes the amplified input signal with a switching signal and outputs a multiplied signal; and
a DC offset compensator that detects the input level of the input signal and outputs a compensation signal based on that detection signal; so that the DC offset included in the output signal of the mixer circuit is compensated by supplying the compensation signal to the mixer circuit,
wherein the DC offset compensator comprises:
a detector of the input signal level that is input to the mixer circuit;
a limiter circuit that attaches a limit to the output of the detector; and
a controller that generates a signal that compensates the DC offset included in the mixer output signal, based on the limited detector output.

2. The frequency mixer according to claim 1, wherein an RF signal is input as the input signal, a local signal is supplied to the switching cell as the switching signal, and an IF signal is output as the multiplied signal from the switching cell.

3. The frequency mixer according to claim 1, wherein the limiter circuit is provided with a transistor that deducts the detector output from a constant current source, and performs a saturation operation when the detector output is larger than the current value of the constant current source.

4. The frequency mixer according to claim 1, wherein the limiter circuit is provided with a feedback loop that operates such that the detector output is matched with a reference potential.

5. The frequency mixer according to claim 1, wherein the DC offset compensator compensates the DC offset by adding the compensation signal to the output signal of the input cell.
